(19) United States
(12) Patent Application Publication
(10) Pub. No.: US 2024/0384201 A1
(43) Pub. Date: Nov. 21, 2024

(54) SYSTEM FOR REMOVAL OF LIPIDS FROM PLANTS AND SEEDS

(71) Applicant: Extraction Alternatives Research & Development LLC, Edmond, OK (US)

(72) Inventors: Patricia Klee, Edmond, OK (US); Arland H. Johannes, Stillwater, OK (US); Joshua D. Ramsey, Stillwater, OK (US)

(21) Appl. No.: 18/545,731

(22) Filed: Dec. 19, 2023

Related U.S. Application Data
(60) Provisional application No. 63/502,533, filed on May 16, 2023.

(51) Int. Cl. C11B 1/04

(52) U.S. Cl. CPC C11B 1/04

(57) ABSTRACT

An apparatus, system, and method to remove lipids from cellular matrices such as but not limited to starches, sugars, proteins, fibers, and so forth, from a wide variety of oil bearing agricultural, edible, botanical, herbal commodities and combinations thereof that provides a superior oil product and also superior shelf stable dried plant and or seed defatted product that may utilize a closed system with a storage vessel, extraction vessel, primary separator, a secondary separator and so forth.

### CROSS-REFERENCE TO RELATED APPLICATIONS

This application claims priority to U.S. Provisional Patent Application Ser. No. 63/502,533, filed on May 16, 2023, currently pending, and incorporated herein by reference in its entirety.

### BACKGROUND OF THE INVENTION

### 1. Field of the Invention

In general, the present invention relates to removal of lipids, such as oils, from plants, oil seeds, tree nuts, and grains. More particularly, the present invention provides an apparatus, system, and method to remove lipids from such as but not limited to starches, sugars, proteins, fibers, and so forth, from a wide variety of oil bearing agricultural, edible, botanical, herbal commodities, and combinations thereof that provides a superior oil product and defatted raffinate co-product that is whole in nutritional content and natural. Nothing is removed from the oil and nothing is added to it. The oil is gently separated from the matrix of the dry fraction of the commodity. Nothing else is removed from the dry fraction and nothing is added to it. The oil can be decanted directly from the extractor with most commodities. It requires no chemical refining, bleaching, deodorizing, or stripping. The oil typically requires only minimal filtering, or a short “winterization” settling, if any. Any filtered lipid exudate is often a marketable product. The oil is of exceptional clarity as it is extracted in a closed system in the absence of oxygen or light, and never exposed to high shear forces, friction, high heat, high pressure, or atmospheric debris. The natural color bodies are intact. The natural aromatic body is intact. The natural nutritional content is retained. After it is prepared for extraction, moisture at a calibrated and desirable percentage level is retained in the solid (non-liquid) fraction of the commodity during the extraction process, and in the dry fraction of the commodity post extraction. Prior art cannot produce calibrated, moisture intact dry raffinates after lipids are removed.

As an example, natural Gamma Tocopherol is retained if present in the raw commodity: Gamma Tocopherol is destroyed in oils that are extracted in the presence of high heat or high pressure. “High heat” or non-ambient heat, is defined as any temperature over 104° F. With most oil (wet) commodities, shelf life stability is 2 to 5 years or greater, if kept in a sealed, glass container at ambient room temperature. Prior art cannot produce oils of that quality. Most dry, defatted commodities will have similar shelf life if properly containerized and kept at ambient temperature. A modicum of calibrated moisture, typically 4% to 8%, is left in the dry raffinate to optimize structural integrity of the commodity to temper the powdering or dusting of the texture. A modicum of residual moisture in the defatted, dry fraction commodity is desirable to facilitate material handling. The minimal moisture content does not compromise shelf-life stability.

### 2. Description of the Prior Art

The global appetite and consumer trends in favor of minimally processed, plant based proteins is increasing. Plants and oil seeds are typically processed to remove oil content to create two products, one wet (lipids) and one dry (carbohydrates, proteins, fiber). The resulting co-products are plant and or seed derived oils and a dry fraction, defatted co-product of the plant and or seed.

The current prior art for leafy greens, botanicals, or vegetables typically utilizes freeze drying, which has undesirable results such as structural damage to the commodity, loss of fresh aroma, body, color, and so on. When freeze drying, the leaf or plant waxes and lipids are not removed, which leaves the unextracted lipids (oils) and waxes in the dried leaf and the end dry product less desirable, less shelf stable, vulnerable to rancidity, and discoloration.

Therefore, it is desirable to provide an alternative to prior art freeze drying and produce superior products that retain fresh aromatic body, color, and so forth that can be used for all leafy greens, herbs, botanicals, peppers, and many vegetables wherein the leaf or plant waxes and lipids are removed, creating a shelf life stable product that does not become rancid and produces a viable wet fraction extract.

The Stabilized Leaf Process (‘STBL’ trademark) is a unique method for the preservation and or shelf life extension of herbs and leafy greens. Unlike conventional vacuum freeze drying, or tray freeze drying, which ruptures the cell walls and inhibits rehydration, the STBL process removes most of the moisture (typically 92%) through air flow. The lipid bodies are removed by a liquefied gas wash. The process is gentle. It does not rupture the cell walls. As the lipid is removed, the source of rancidification is eliminated that causes off flavors, aromas, and degradation of natural color typical in conventional freeze drying. The process works through combining controlled ambient temperature air flow drying followed by the liquefied gas “rinse” to remove cuticular waxes and surface oils.

The above discussed limitations in the prior art are not exhaustive. The current invention provides an inexpensive, energy efficient, time saving, more reliable apparatus, and method of use for superior results where the prior art fails.

### SUMMARY OF THE INVENTION

In view of the foregoing disadvantages inherent in the known types of plant and seed extraction now present in the prior art, the present invention provides a new and improved alternative to freeze drying and produces superior products that retain fresh aromatic body, color, and flavor. As such, the general purpose of the present invention, which will be described subsequently in greater detail, is to provide a new and improved extraction apparatus, system, and method of using the same, which has all the advantages of the prior art devices and none of the disadvantages.

To attain this, the present invention essentially may comprise a closed system generally having an extractor vessel that retains the organic matrix while a liquefied gas passes through the vessel. The embodiment may include, but is not limited to, (i) a “static” extractor in which the organic matrix remains fixed within the vessel and the liquefied gas is capable of flowing in a forward and or reverse direction; (ii) a “turbulent flow” extractor that has liquefied gas flowing through the extractor in such a manner as to gently mix the organic matrix material by using liquefied gas vortices, without internal mechanical moving parts, but does not carry the material out of the extractor; and or (iii) a “horizontal plow mixer” extraction vessel that vigorously agitates and mixes the commodity by use of mechanical paddles within the extractor vessel to create uniform exposure of the commodity to the liquefied gas.

Before the extraction process is started, a liquefied light gas hydrocarbon gas is loaded into the storage vessel and the solid commodity is loaded into the extraction vessel, respectfully. In order to fully remove oxygen from the system, a vacuum is then pulled and maintained throughout extraction system, and residual oxygen is vented to atmosphere.

During the extraction process, the liquid hydrocarbon flows from the storage vessel to the extraction column. The hydrocarbon liquid flows through the extractor where it contacts the organic matrix or commodity. Within the extraction vessel, oils and waxes, and some water depending on the commodity, from the commodity move from the solid organic matrix into the hydrocarbon liquid stream. The oil-laden hydrocarbon liquid stream leaves the extraction vessel and passes through a valve that decreases the pressure on the stream, causing the light hydrocarbon to flash and or vaporize while leaving the oils, waxes, and or water in a liquid and or amorphous state.

The two-phase stream enters the oil and liquefied gas separator vessel where the oils and or waxes and or water are separated from the light hydrocarbon vapor and retained within the vessel. The light hydrocarbon vapors, carrying little-to-no oil and or waxes, then move from the primary oil liquefied gas separator to the secondary separator. Any oil and or waxes and or water that were not removed from the hydrocarbon gas in the primary oil-solvent separator are removed in this second vessel.

The light hydrocarbon gas is recirculated within the process. The nearly pure, light hydrocarbon vapor leaving the secondary separator vessel may be compressed and recycled to the liquefied gas storage tank. Because compression adds heat to the vapor, the hydrocarbon vapor leaving the compressor may have been heated to a high of 120° F. and must be cooled and condensed in the jacketed liquefied gas storage vessel.

Once the extraction process is completed and the light hydrocarbon gas is completely recovered and isolated in the liquefied gas storage vessel, the system can be opened to the atmosphere. The oils, waxes, gums, and or water that were collected in the primary oil-liquefied gas separator are drained from the vessel, and the mostly oil-free, typically at <1% residual oil content, commodity is removed from the extractor. The liquefied hydrocarbon gas recovery step removes most of the hydrocarbon that may have been adsorbed onto the solid organic matrix of the commodity. Any minimal residual liquefied hydrocarbon gas or vapor that may be in the recovered oil and or waxes is stripped by pulling a vacuum, or sparging nitrogen through the system, and or the oil, or use of both in sequence or combination.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Therefore, it is an object of the present invention to provide a new and improved chemical process method of lipid extraction, functioning at ambient temperature (less than about 105° F.) and low pressure (less than 100 psia) and or oil seed extraction apparatus, and or leafy greens and botanicals extraction apparatus, system, and method of using the same, which may provide superior end wet products as well as superior shelf stable dry products.

It is a further object of the present invention to provide a new and improved plant and or oil seed extraction apparatus and or leafy greens and botanicals extraction apparatus, system, and method of using same, which may be easily and efficiently manufactured and marketed.

An even further object of the present invention is to provide a new and improved chemical process and or oil seed extraction apparatus, and or leafy greens and botanicals extraction apparatus, system, and method of using same, which is susceptible to an efficient use of energy and favorable economic cost in comparison to prior art of manufacture and use with regard to both materials and labor, and which accordingly is then susceptible to lower prices of sale to the consuming industry, thereby making such value economically available to consumers.

Still another object of the present invention is to provide a new and improved chemical process and or oil seed extraction apparatus, and or leafy greens and botanicals extraction apparatus, system, and method of using same, which provides all of the utilitarian advantages of the prior art, yet exceeds the prior art in production, while simultaneously overcoming the disadvantages normally associated therewith.

Another object of the present invention is to provide a new and improved chemical process and or oil seed extraction apparatus, and or leafy greens and botanicals extraction apparatus, system, and method of using same that may produce superior products that retain fresh aromatic body, color, and flavor. with durable shelf life stability beyond that attainable by prior art.

Yet another object of the present invention is to provide a new and improved chemical process and or oil seed extraction apparatus, and or leafy greens and botanicals extraction apparatus, system, and method of using same that are expandable and flexible and can be designed to process a few tons per day, to hundreds or thousands of tons per day.

An even further object of the present invention is to provide a new and improved chemical process and or oil seed extraction apparatus, and or leafy greens and botanicals extraction apparatus, system, and method of using same that is environmentally friendly in a closed system.

Still another object of the present invention is to provide a new and improved chemical process and or oil seed extraction apparatus, system, and method of using same that can be used for seeds, all leafy greens, herbs, botanicals, peppers, and many vegetables.

Yet still another object of the present invention is to provide a new and improved chemical process and or oil seed extraction apparatus, system, and method of using same that provides superior extraction of oils, resins and defatted, protein intact flours from tree nuts, edible oil seeds, herbs, leafy greens, and botanicals.

Still another object of the present invention is to provide a new and improved chemical process and or oil seed extraction apparatus, system, and method of using the same wherein proteins are kept fully intact and un-denatured in the dry fraction of the commodity, resulting in superior digestibility, and often with a superior Protein Dispersibility Index (PDI). As many lipids are utilized by the plant, seed, or grain to protect against environmental attack (insects, solar radiation, heat, cold, dust, lack of water, etc.), they often contribute undesirable aromas and flavors; further, they impede digestion of nutrients otherwise available in the plant material. Removing these lipids can improve flavor, palatability digestion, and protein dispersibility for both animal and human consumption while providing a functionally limitless shelf life.

It is a further object of the present invention to provide a new and improved chemical process and or oil seed extraction apparatus, and or leafy greens and botanicals extraction apparatus, system, and method of using same, which may be performed at ambient conditions or as low as −10° F. (wherein at atmospheric pressure, liquid propane is −40° F.).

An even further object of the present invention is to provide a new and improved chemical process and or oil seed extraction apparatus, and or leafy greens and botanicals extraction apparatus, system, and method of using same that is capable of extracting oils and or waxes at levels not typically achieved by other processes. Wherein the desired product is the extracted oil, the current invention results in greater yields, purity, and clarity in the oil than many other extraction processes (such as by expeller or extruder methods), Wherein the desired product is the defatted (dry) product, the current invention yields a product with a lower oil and or wax content. Furthermore, whole in material content, wet and dry marketable co-products are also created, unlike prior art, which typically creates a waste stream of one of the co-products.

Still another object of the present invention is to provide a new and improved chemical process and or oil seed extraction apparatus, and or leafy greens and botanicals extraction apparatus, system, and method of using same, which extracts color bodies and other lipid components thought to improve the quality of the oil over oil extracted using other techniques that leave these components behind in the solid organic matrix.

Another object of the present invention is to provide a new and improved chemical process and or oil seed extraction apparatus, and or leafy greens and botanicals extraction apparatus, system, and method of using same that produces defatted products that are more shelf stable. The greater amount of oil and or wax removed results in a product that is more shelf stable and less likely to go rancid. The process may be used to stabilize leafy herbs such as basil, cilantro, and leafy vegetables such as spinach resulting in a product that has a longer shelf life and does not need to be refrigerated. Similarly, a stabilized, defatted protein intact dry raffinate flour product has been produced that is ready for next step protein concentration or isolation processing.

Yet another object of the present invention is to provide a new and improved chemical process and or oil seed extraction apparatus, and or leafy greens and botanicals extraction system, and method of using the same wherein the process is highly efficient at removing residual light hydrocarbon from the solid organic matrix and or the extracted oil. This results in a product that is free residual liquefied gas or vapor, with traits, such as but not limited to taste, smell, and so forth that is unadulterated or denatured by the solvents or liquefied gasses used in the extraction process.

These, together with other objects of the invention, along with the various features of novelty, which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there are illustrated preferred embodiments of the invention.

### BRIEF DESCRIPTION OF THE PICTORIAL ILLUSTRATIONS, GRAPHS, DRAWINGS, AND APPENDICES

The invention will be better understood and objects other than those set forth above will become apparent when consideration is given to the following detailed description thereof. Such description makes reference to the annexed pictorial illustrations, graphs, drawings, and appendices wherein:

FIG. 1 is a general illustration of a preferred embodiment in accordance with the current invention.

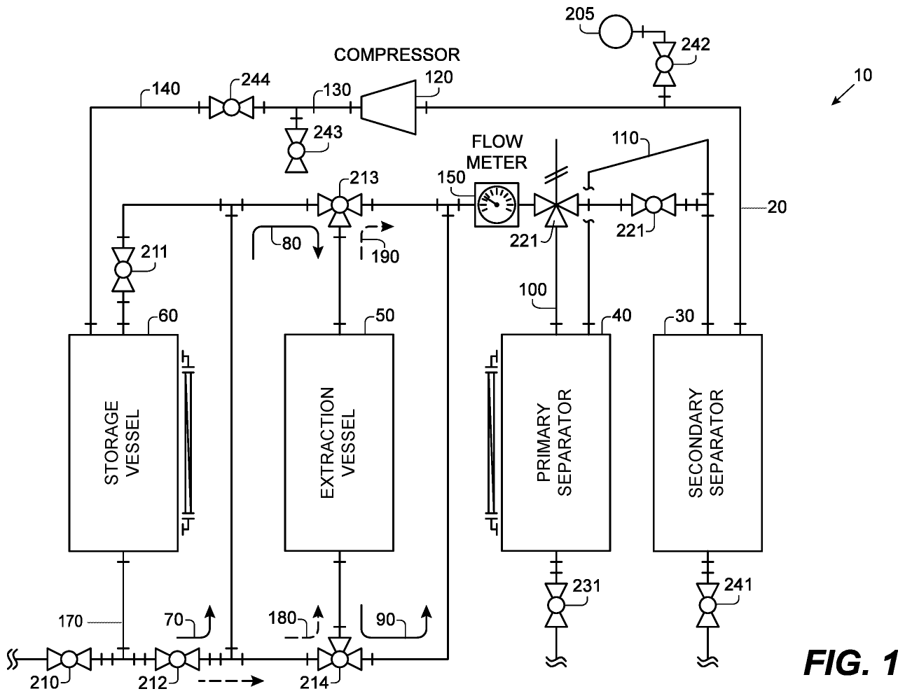

FIG. 2 is a general illustration of a preferred embodiment in accordance with the current invention.

FIG. 3 is a general illustration of a preferred embodiment in accordance with the current invention.

FIG. 4 is a general illustration of a preferred embodiment in accordance with the current invention.

### DETAILED DESCRIPTION OF THE PREFERRED EMBODIMENTS

Referring to the illustrations, drawings, and pictures, reference character 10 generally designates a new and improved chemical process and or oil seed extraction apparatus, and or leafy greens and botanicals extraction apparatus, system, and method of using same in accordance with the present invention. Invention 10 is generally used in conjunction with organic plants and or oil seed extraction. It is contemplated that invention 10 may be utilized for other applications.

The present invention essentially may comprise a closed system 20 generally having a static extractor and or extraction vessel 50 where the organic matrix (e.g., organic plant material-leaves or oil seeds) is retained in the extractor 50 and where the flow of solvent is reversible. The extraction further utilizes a primary liquified gas, oil, and or water separator 40, a secondary gas, oil, and or solvent separator 30, a liquefied gas and or solvent collector and or storage vessel 60, and so forth utilizing a light hydrocarbon solvent liquid and a solid organic commodity. It is also understood that a compressor and or pump and a recycle line may be included.

Before the extraction process is started, a light hydrocarbon liquid and a solid commodity are loaded into the liquefied gas collector 60 and extraction vessel 50, respectively. A vacuum is then pulled and maintained throughout the extraction system. During the extraction process, the liquid hydrocarbon flows from the liquid gas collector 60 to the extraction vessel 50 via stream 70 and or stream 170 depending on the direction of the flow. The hydrocarbon liquid flows through the extractor 50 where it contacts the commodity. Within the extraction vessel 50, oils, waxes, and or water from the commodity move from the solid matrix into the hydrocarbon liquid stream 90 and or 190. The oil-laden hydrocarbon liquid stream 90 and or 190 leaves the extraction vessel 50 and passes through a valve 221 that drops the pressure of the stream 100, causing the light hydrocarbon to flash and or vaporize while leaving the oils and or waxes and or water in a liquid state or amorphous state. The two-phase stream 100 enters the primary oil separator 40 where the oils and or waxes and or water are separated from the light hydrocarbon vapor and retained within the oil-solvent separator 40. The light hydrocarbon vapors, with little-to-no oil and or waxes, then move from the oil-solvent separator 40 to the secondary separator 30 via stream 110. Any oil, waxes, and or water that was not removed from the hydrocarbon solvent in the primary oil-solvent separator 40 are removed in this secondary separator 30.

The nearly pure, light hydrocarbon vapor leaves secondary separator 30 via stream 110 and is compressed and recycled by a hydrocarbon compressor or pump 120 to the solvent collector 60. Because compression adds heat to the vapor, the hydrocarbon vapor leaving the compressor 120 via stream 130 may be heated above 104° F. and should be cooled and condensed in the jacketed solvent collector 60.

Once the extraction process is completed, and the light hydrocarbon solvent is completely recovered in storage vessel 60, the system can be opened to the atmosphere. The oils and or waxes that were collected in the oil-solvent separator 40 are drained from the oil-solvent separator 40 via stream 231, and the oil-free commodity is removed from the extractor 50. The hydrocarbon gas recovery step removes most of the hydrocarbon that may have been adsorbed onto the solid organic matrix. Residual hydrocarbon gas that may be in the recovered oil and or waxes and or water is stripped by sparging nitrogen through the oil and pulling a vacuum. It is understood that invention 10 may be a process that removes the natural waxes and oils found on and within organic plant material. In some cases, the defatted value-added dry product is the extracted lipid material, such as but not limited to, soybean oil, pecan oil, rice bran oil, frankincense oil, echinacea seed oil, resins, plant leaf waxes, and so forth. In other cases, the value-added product is the material left behind after extraction. Having had the oil, waxes, gums and impure oily compounds such as color bodies, or lipid debris, extracted from the commodity the product may be a stabilized leaf product such as but not limited to basil, cilantro, spinach, and so forth, and or a defatted high protein product that can be processed to produce a flour such as but not limited to soybean flour, pecan flour, chickpea flour, echinacea seed flour, and so forth and or a crude solid that is blended to produce an animal feed.

It is understood that invention 10 may be a process that removes water from the commodity. The amount of water that is removed from the commodity is dependent on the particular commodity and the pretreatment process. Some commodities, such as those intended as stabilized leaf products, may undergo an initial dehydration step where some portion of the water is removed from the material that is to be treated in the extraction process. Other commodities may not undergo a dehydration pretreatment step and, additionally, may contain more water that may be removed during the extraction process. Some of the water that is removed from the commodity is dissolved in the liquid hydrocarbon solvent. The solubility of water in the liquid hydrocarbon solvent; however, is generally quite low. Additional water that may be removed from the commodity exists as a separate liquid phase from the oil and hydrocarbon solvent phase. In both cases, the dissolved water and free water are separated from the hydrocarbon solvent in the primary separator 40 and or secondary separator 30. Minute amounts of water vapor may be recycled with the hydrocarbon solvent and thus collect in the hydrocarbon storage vessel 60. This water may be removed from the process by purging small amounts of the hydrocarbon solvent or completely replacing the hydrocarbon solvent.

It is also contemplated invention 10 may provide a more desirable process for how best to mix the liquefied hydrocarbon gas and the organic solid matrix. Invention 10 may retain the solid matrix within the extraction vessel 50 by loading it into a cotton sleeve that prevents the solid material from being suspended in the hydrocarbon liquid and carried out of the extractor 50.

In a preferred embodiment, liquefied gas may be but is not limited to odorless propane, which provides good chemical characteristics for solubilizing and removing oil from the solid matrix. Invention 10 may utilize a mixture of light hydrocarbons for the liquefied gas phase. Extracting oil from the solid matrix of an organic commodity with a hydrocarbon solvent is a combination of two modes of mass transfer: diffusive mass transfer and convective mass transfer. Convective mass transfer is the term used to describe the transfer of oil from the surface of the solid matrix into the solvent around the solid. Diffusive mass transfer, or diffusion, is the term used to describe the movement of oil within the solid matrix. The rate at which oil is removed from the solid matrix and the total amount of oil that is removed is ultimately limited by these two modes. The effective diffusivity of the oil within the organic matrix is improved by altering the oil and or solid matrix system so as to produce a new medium through which the oil is diffusing. The approach is to use liquefied hydrocarbon gasses that can penetrate into the solid matrix and produce a new solid and or liquefied hydrocarbon gas pseudo-solid. The diffusivity of the oil within the pseudo-solid is significantly higher than the diffusivity of the oil within the solid matrix alone. The challenge of using a hydrocarbon capable of penetrating the solid matrix and performing the oil extraction is that each of these mechanisms require opposing traits. Larger molecular weight hydrocarbons are desired to maximize the partition coefficient and solubility of oil in the hydrocarbon liquefied gas phase. Yet, low molecular weight hydrocarbons are needed to permeate into the solid matrix and increase the effective diffusivity. To address this challenge, the invention is capable of using a hydrocarbon mixture of propane and a low molecular weight hydrocarbon. The lower molecular weight component permeates the solid matrix, increasing the effective diffusivity, while the higher molecular weight component will maintain a sufficiently high partition coefficient so as to not decrease the convective mass transfer into the liquid gas solvent at the surface.

It is further contemplated that invention 10 may use extraction temperatures range from about 65° F. to about 105° F. near ambient conditions. The hydrocarbon flashing step lowers the temperature of the extracted oil but not so low as to see deleterious effects.

### Pre-Extraction Preparation

In a preferred embodiment, invention 10 contemplates a pre-extraction preparation that may include, but is not limited to the following.

The leafy greens are left in sealed containers until they are removed for particle size reduction with a preferred removal within two hours of delivery. If commodity in excess of dehydrator capacity is delivered, the excess commodity may be rolled into 100% cotton cloth, light weight toweling and refrigerated in the cotton rolls, until ready for particle size reduction.

The commodity is placed into the dehydrator immediately after particles size reduction within minutes. Leafy greens and or botanicals may be greenhouse grown, in aeroponic or hydroponic towers. It is contemplated that greenhouse grown commodities may be clean and have been rinsed prior to harvest. They may or may not require washing before the particle size reduction task is employed.

Leafy greens grown in the field may require washing with cool water in a clean, food grade facility and are then dried on racks by ambient air flow only (+ “room temperature” or +68° F.) prior to particle size reduction.

The clean or washed leafy greens are then particle size reduced according to cultivar type and size of leaf. As an example, basil may be de-stemmed and the leaves may be sliced with a porcelain bladed knife or porcelain blade cutting device to reduce the leaf size into quarters or thirds of the natural, on stem size at harvest. By example, the size of the basil leaf slices may be about 1 inch wide by 1.5 inches long. That may be a typical reduction size for most botanicals.

It is contemplated that porcelain cutting devices are only used for particle size reduction to avoid reaction of the leafy green with metal which can accelerate the oxidation or discoloration of the leaf. For example, basil reacts immediately when sliced with metal and discolors quickly.

It is known that some herbs such as parsley and or cilantro are not typically de-stemmed, other than the stem base end being trimmed off if it has become stalk like or woody. The leafy fronds may be reduced in size by slicing into sections of about 1 inch by 2 inches, including stem section.

When the greens are reduced in size from their natural conformation, they may be placed on stainless steel wire shelves in layers typically not exceeding 0.5 inches in depth. The shelves are then placed into a dehydrator and dried down to a moisture content of ±8% to 10% residual moisture. The greens may not be dehydrated to 0% moisture as a modicum of moisture is desirable to maintain the structural integrity of the leaf.

The particle size reduced greens may be placed on a perforated silicon mat that may be placed over the stainless steel wire shelves, depending on the particle size and the moisture content of the fresh commodity. In a preferred embodiment, the greens are dehydrated by air flow only, at between 68° F. and 86° F. for typically about 6 to about 24 hours, depending on moisture content.

When the greens are adequately dehydrated they are removed from the dehydration units and placed in but not limited to 100% cotton bags. The bags are then placed in the extractor vessel 50. If the dehydrated greens are in the queue for the extractor vessel 50, but waiting for their turn, they may remain in the bags, in a staging area, typically for about 24 hours until processing space is available in the extractor.

### In Operation of a Preferred Embodiment

### Extraction Procedure

In a preferred embodiment, but not considered to limit invention 10, the following procedure may be utilized.

1. Leak check procedure with vacuum by evacuate the entire system to ensure exclusion of oxygen from the system and check for the leaks.

a) Open valves relief valve 221, ball valve 241, ball valve 242 and vacuum gauge 205, and ball valve 243 (vent). Orient the three-way valves ball valve 213 and ball valve 214 so that flow occurs in the ‘forward’ direction along streams 80 and 90. All other valves may be closed.

b) Turn on vacuum pump 120, until the entire system is under vacuum (minimum about 6.5˜7 in. H20, optimum 25-28 in. H20).

c) Turn off vacuum pump 120 and wait for about two minutes. Recheck that vacuum gauge 205 has not changed to ensure that no gross leaks are present. It is contemplated to continue to next step only after confirming that the system is totally evacuated. It is also contemplated to open all valves slowly. This is also a safety precaution for operation of vacuum pump vacuum pump 120.

2. Loading propane: Fresh high-purity, food grade propane from a non-odorized source (Airgas, instrument grade) with a dip tube serves as the source for propane. The system must first be evacuated as detailed in Step 1, except that ball valve 211 and ball valve 212 are also open during evacuation to evacuate storage vessel 60. All system components should be cleaned and dried prior to charging with propane. All connections should be checked for tightness prior to initiation of this operation. primary separator 40 and secondary separator 30 should be pre-heated to about 95-100° F. and storage vessel 60 should be precooled to 40° F. or below prior to initiation of this operation.

a) Open valves ball valve 211, ball valve 212, ball valve 221, relief valve 221, ball valve 242, and ball valve 243. Orient the three-way valves ball valve 213 and ball valve 214 so that flow occurs in the ‘forward’ direction along streams 80 and 90. All other valves should be closed.

b) Turn on vacuum pump 120 and apply vacuum to entire system. Perform leak check procedure as in Step 1, and then close ball valve 211, ball valve 212 and ball valve 221.

c) Close ball valve 242. Detach pressure gauge 205 from the system and attach filling line from the instrument grade propane source to the system. Open ball valve 242.

d) Turn on vacuum pump 120 to assure evacuation of any air during filling line attachment, then turn off vacuum pump 120.

e) Close ball valve 243 and open ball valve 244. The system is now ready to start loading fresh propane.

f) While running vacuum pump 120, initiate flow of propane by slowly opening the propane filling line ball valve. Continue slow flow until frost thaws on the tubing under ball valve 242, and then open the valve completely.

g) Adjust pumping rate of vacuum pump 120 to avoid buildup of propane in secondary separator 30—look at the sight glass tube (level gauge not shown) of secondary separator 30.

h) Continue filling operation until storage vessel 60 is approximately ⅔ full—fill less if there is a notable accumulation in secondary separator 30.

i) Close the propane filling line ball valve and continue pumping until pressures in secondary separator 30 and primary separator 40 are less than 20 psi. Close ball valve 242 and disconnect the propane filling line. Reconnect pressure gauge 205 and open ball valve 242. Continue pumping operation to bring the system to vacuum (20-25 in. H20). Observe propane level in storage vessel 60 during the filling operation. If level exceeds ¾ full, stop operation of vacuum pump 120, close ball valve 244 and burn off an approximate amount of propane (see propane disposal) to allow filling with remaining vapors to the proper propane level. If frost builds at the bottom of secondary separator 30, turn off vacuum pump 120 and close ball valve 244 and allow frost to thaw. Restart by first opening ball valve 244 and then starting vacuum pump 120.

j) After achieving full vacuum, turn off vacuum pump 120 and close ball valve 244. Open ball valve 241 at the bottom of secondary separator 30 to release vacuum on system. The system is now ready for use.

3. Loading the extraction vessel (extraction vessel 50): All materials to be extracted are preloaded into such as but not limited to non-bleached 100% cotton pull string bags. Bags should be pre-weighed and bag number, bag tare weight, and bag full weight should be recorded. Prior to loading, primary separator 40 and secondary separator 30 should be pre-warmed to 95-100° F. Observe that the propane level in storage vessel 60 is appropriate to carry out the planned extraction. Assure that all valves on storage vessel 60 are closed prior to proceeding.

a) Assure that no vacuum is on the system by opening and closing ball valve 241 at the bottom of secondary separator 30.

b) Remove the top plate of extraction vessel 50, the associated tubing and valves, and the gasket and or filter screen.

c) Load bag into extraction vessel 50 with material to be extracted.

d) Reattach the extractor top plate and associated tubing and valves securely.

e) Assure that all connections are tight with proper gasket placement before proceeding with the evacuation and or extraction step.

4. Extraction procedure: Extraction is carried out immediately following extraction vessel 50 loading. Assure that extraction vessel 50, primary separator 40 and secondary separator 30 are at proper running temperature and all fittings are tight prior to initiating a run.

a) Conduct system evacuation and check for leak, as described in Step 1.

b) Just prior to application of liquid propane to extraction vessel 50, assure that ball valve 243 and ball valve 221 are closed. ball valve 242 should be open.

c) Orient the three-way valves ball valve 213 and ball valve 214 so that flow occurs in the ‘forward’ direction along streams 80 and 90, and initiate liquid propane flow by slowly opening ball valve 212 at the bottom of storage vessel 60. Allow pressure to nearly equilibrate between storage vessel 60 and extraction vessel 50, and then open ball valve 244 and start vacuum pump 120.

d) Adjust relief valve 221 for desired flow of miscella (about 0.1 gpm reading or below) while watching the level gauge on the propane storage vessel. Adjust vacuum pump 120 pumping rate to maintain no more than about 90-120 psi in primary separator 40. Continually adjust relief valve 221 to maintain desired flow—never exceed ½ liquid fill in primary separator 40.

e) At regular intervals, reverse the flow of propane through extraction vessel 50 by alternating the orientation of the three-way valves ball valve 213 and ball valve 214. The frequency of alternating the flow direction is dependent on the product being extracted, with finer milled products requiring more frequent changes in the flow direction.

(i) If operating in the forward direction (stream 80 and or stream 90), first change the orientation of ball valve 213 to enable flow along stream 190, and then change the orientation of ball valve 214 to enable flow along stream 180.

(ii) If operating in the reverse direction (stream 180 and or stream 190), first change the orientation of ball valve 214 to enable flow along stream 90, and then change the orientation of ball valve 213 to enable flow along stream 80.

f) High pressure soaks and or pressure pulsation may increase the extraction efficiency. To perform a high pressure soak, follow the procedure.

(i) Orient valve ball valve 213 so as to enable forward flow, and orient valve BALL VALVE-1 so as to enable reverse flow.

(ii) Close ball valve 212 to prevent possible back flow into the storage vessel and contamination of the propane.

(iii) Open ball valve 211 and allow pressure in the extraction vessel to increase. Close ball valve 211 once the desired pressure is reached in extraction vessel 50.

(iv) During the soak time, turn off vacuum pump 120 to prevent from pulling a vacuum on primary separator 40 and secondary separator 30.

(v) Once the desired soak time has been reached, slowly orient valve ball valve 213 in the reverse flow direction and restart vacuum pump 130.

(vi) Immediately open valve ball valve 212, and adjust and or monitor valve relief valve 221 to maintain the desired flow rate until steady state is reached.

g) Note and record any color change of the miscella in the level gauge of primary separator 40 during extraction. Continue extraction with continuous flow of propane for the desired amount of time. Note that since a flow meter 150 is calibrated for water (d=1.0), the flow for propane must be corrected by dividing the flow by the density of liquid propane (d=0.582 at the boiling point of propane, −47.1° C.). Therefore, the flow for propane is calculated as 0.172 gpm (0.100/0.582=0.172 gpm), which is 0.652 liters per minute (Lpm). If 0.653 L propane circulates per minute, 5 L of propane circulates for 7.669 minutes in the system. Therefore, at 0.1 gpm H20 (0.379 Lpm) it takes 7.669 minutes to complete one 5-L change of propane through extraction vessel 50.

h) During this procedure pressure and temperature in storage vessel 60 will increase. Do not exceed 270 psi in storage vessel 60. If pressure climbs to 270 psi, then either (1) provide additional cooling of storage vessel 60 or (2) turn off vacuum pump 120 and close ball valve 244 and allow pressure to decrease (via normal storage vessel 60 cooling) prior to restarting.

i) To end a run, close ball valve 212 at the bottom of storage vessel 60, orient ball valve 213 and ball valve 214 so as to enable ‘reverse’ flow (180 and or 190), and perform the following procedure:

(i). After closing ball valve 212, open relief valve 212 until flow is noted, maintain >0.1 gpm flow rate but do not fill primary separator 40 over ½ full with liquid.

(ii) The liquid level in extraction vessel 50 will decrease and pressure will decrease during unloading.

(iii) After the liquid level is below the sight glass tube for extraction vessel 50, feel the tubing-when liquid is gone and vapors are predominant, the tube will become noticeably colder. Turn on heated liquid to extraction vessel 50 to prevent excessive chilling during propane vaporization. If necessary turn down heater to prevent the raffinate from overheating. For certain substrates a rapid removal of propane liquid from extraction vessel 50 can be achieved by opening ball valve 211 on top of storage vessel 60 and allowing pressure in storage vessel 60 to push liquid solvent out of extraction vessel 50. Prior to opening ball valve 211, assure that liquid level in primary separator 40 is lower than ¼ full and that relief valve 221 is opened enough to register flow. Open ball valve 211 slowly and keep it open until liquid level in primary separator 40 no longer increases. At this point, extraction vessel 50 is unloaded of liquid propane and ball valve 211 should be closed.

(iv) When extraction vessel 50 is empty (3-10 minutes depending on flow rate out of extraction vessel 50) watch liquid decrease in primary separator 40. For certain extracts foaming may occur during final vaporization from primary separator 40. If foaming reaches the top of primary separator 40, stop vacuum pump 120, close ball valve 244 and allow foam to settle (5 minutes is usually sufficient). After foam is settled, open ball valve 244 and start vacuum pump 120 to vaporize remaining propane. Repeat stop if necessary to prevent foam and oil transfer into secondary separator 30.

(v) Continue vaporizing propane from primary separator 40. When pressure reduces to 40-60 psi, no liquid is observable in the primary separator 40 sight glass tube, and no foaming is apparent, open ball valve 221 slowly. Note flow from flow meter 150 and do not exceed 0.6 gpm during opening. Once flow reduces to less than 0.1-0.2 gpm and is steady, open ball valve 221 completely. If foaming is noted, do not open ball valve 221 until foaming subsides to avoid foam transfer into secondary separator 30. After opening ball valve 221, extraction vessel 50 is open to primary separator 40 and secondary separator 30 and hydrocarbon vapors are being removed from the entire system. Note temperature and pressure during vaporization-pressures should continuously decline from extraction vessel 50 to primary separator 40 to secondary separator 30 and temperatures should increase, especially in extraction vessel 50 and primary separator 40. Adjust heater temperature or heating liquid flow (valve at top outlet of vessels) to maintain temperature at desired level. Note pressure of storage vessel 60 and do not exceed 270 psi.

(vi) Vaporization is complete when pressure gage 205 reads a vacuum of about 20 in. or higher. Stop vacuum pump 120 and close ball valve 244.

5. Extract unloading procedure: Upon initiation of this procedure, the vacuum may first be released and air enters secondary separator 30, primary separator 40, and extraction vessel 50. Before initiation of this procedure assure that ball valve 244, ball valve 211, and ball valve 212 are all closed to ensure propane does not mix with incoming air.

a) Open ball valve 241 at the bottom of secondary separator 30 and slowly release vacuum on secondary separator 30, primary separator 40, and EV-1. Place extract recovery bottle under ball valve 241 during this operation to recover any extract which may have entered secondary separator 30 during operation. Once vacuum is completely released and extract (if present) is removed, close ball valve 241.

b) Place extract recovery bottle under ball valve 231, at the bottom of primary separator 40, and open ball valve 231. Extract should be emptied into the bottle. After all extract is drained into the bottle, close ball valve 231. Extract will be sparged with nitrogen to remove residual propane in a post vacuum post extraction step. When very low extract recoveries are expected, an insert may be placed in the sample cup attached to ball valve 231 or a separate tapered cup may have been installed prior to operation. In this case the extract must be recovered by detaching the sample cup at the bottom of primary separator 40 and manual recovery of extract as follows:

(i) Turn off heated liquid main supply inlet and outlet on sample cup and inlet to extraction vessel 50.

(ii) Turn off inlet and outlet valves and detach via quick connectors from the supply line.

(iii) Disconnect clamp while holding sample cup on to PRIMARY SEPARATOR 40, carefully holding sample cup to avoid dropping and spilling extract. Retain sample cup gasket with sample cup.

(iv) Transport sample cup carefully into lab and recover extract. Note: Heating fluid retained inside the cup may require hot-use gloves to handle the sample cup.

(v) Clean and dry sample cup and gasket.

(vi) Replace sample cup onto primary separator 40, taking care that gasket is properly placed prior to tightening the clamp.

(vii) Reattach heated liquid tubes and turn valves back on. Observe that fluid flow is on for primary separator 40 and extraction vessel 50 jackets.

6. Raffinate unloading procedure: Raffinate is usually unloaded while extract is draining through primary separator 40 (see Step 4) or prior to detachment of the sample cup (see Step 5ii). Be certain that propane supply is isolated from extraction vessel 50, primary separator 40 and secondary separator 30 and that vacuum is released prior to this operation. This would be accomplished by proper execution of Step 4 prior to this step.

a) Detach ball valve 213 and the associated tubing from the top plate of extraction vessel 50. Taking care that gaskets are also removed. A small amount of vacuum may be released at this time which is normal.

b) Remove clamp from top cap of extraction vessel 50 and place onto the table.

c) Remove top cap from extraction vessel 50 and retain cap filter gasket-place onto table.

d) Remove raffinate bag from extraction vessel 50 and obtain weight. Raffinate will be sparged with nitrogen gas in a post-extraction step to remove residual propane and reweighed. The raffinate bag may be cold due to propane vaporization.

e) Loosely replace all extraction vessel 50 components to prevent dust contamination and or other atmospheric debris.

### Post-Extraction Product Handling

Wet extracts and dry, defatted solid raffinates are handled differently, depending on nature of product and total volume to be processed. Guidelines are presented separately for extracts and raffinate.

### Extract Handling

Extracts are normally in the form of liquid oils, but may also be semisolids, pastes, waxes and or waxy solids. Liquids which are obtained in sufficient volume to drain through from ball valve 231 at the bottom of primary separator 40 are usually desolventized by sparging with nitrogen with the pressurized sparging vessel. Such extracts will be termed higher volume liquid extracts as opposed to lower volume or solid extracts.

To remove residual propane from higher volume liquid extracts, use the instructions for the sparger given below:

1. Prior to filling sparger assure that both ball valves at the bottom of the unit are closed, and then fill the sparger with about ⅓-½ gallon of oil.

2. Record the temperature of the sparger and pressure at the nitrogen tank. If temperature is lower than 70° F., warm the sparger with warm water. Simulation results indicated that propane is noticeably less soluble in oils with a temperature of less than about 70° F.; solubility remains relatively constant up to 85° F. thereafter.

3. Securely attach sparger top and connect the nitrogen supply to the gas inlet attached to the sparging stone (filtered oil outlet) and sparge with nitrogen.

4. Flow pressure from the nitrogen tank will usually be at 2.0-3.5 psi (outlet pressure). Assure that outlet at top of sparger is open and observe gas flow out of the sparger.

5. Continue sparging until around 500 psi nitrogen has been depleted from the nitrogen cylinder (4-5 hours).

6. Collect the filtered or non-filtered oil from the outlets at the bottom of the sparger. Use nitrogen pressure applied from the top ball valve to force contents into a clean 1 gallon oil jar. If necessary, clean the sparger stone by back flushing nitrogen through stone to improve oil flow rate.

7. After all oil is decanted, place the oil jars under vacuum generated by using a manual vacuum generator to ensure that excess dissolved nitrogen is removed from the oil. Pump manual vacuum generator 100 times for a 1-gallon jar and adjust according to the size of other jars. Oil is ready for packaging after 1-2 hours under vacuum.

### Raffinate Handling

To remove residual propane from the raffinate, nitrogen is sparged through plastic canisters that contain the raffinate. The process is carried out by following the instructions.

1. The sparging system may consists of one or two containers connected to a nitrogen supply and are not suited for pressurization. Connect the system as follows:

a) Connect two 1-gallon plastic canisters using tubing.

b) Connect the twin system to the nitrogen tank gauge outlet.

c) Sparging gases exit the canisters through an outlet hole.

2. Place raffinate bags into the canisters and close the covers tightly. The inlet nitrogen tubing should be placed close to the bottom of the container.

3. Sparge nitrogen for about two hours to remove the propane from samples (reduces nitrogen cylinder pressure by 400-600 psi). Samples should be warm with no cold spots (cold spots indicate propane outgassing). If high retention of propane is expected (occurs mostly in high oil substrates), pre-warm bags prior to sparging by leaving at room temperature for 30 minutes to 2 hours or until bag contents are not cold to touch.

### Flowchart Re a Preferred Embodiment

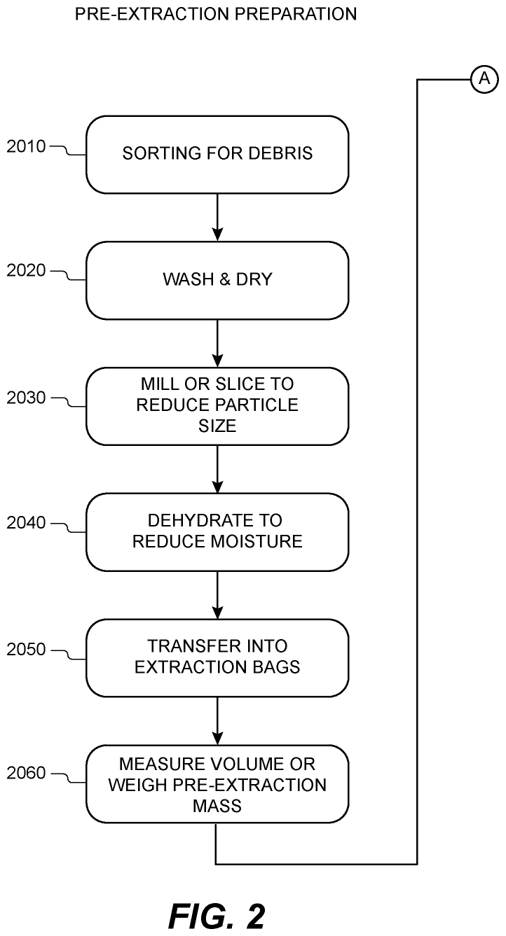

Now referring to FIG. 2, invention 10 contemplates the following steps of sorting for debris 2010, washing and drying 2020, milling and or slicing to reduce particle size 2030, dehydrating to reduce moisture 2040, transferring into extraction bags 2050, measuring volume and or weighing pre-extraction mass 2060, and so forth.

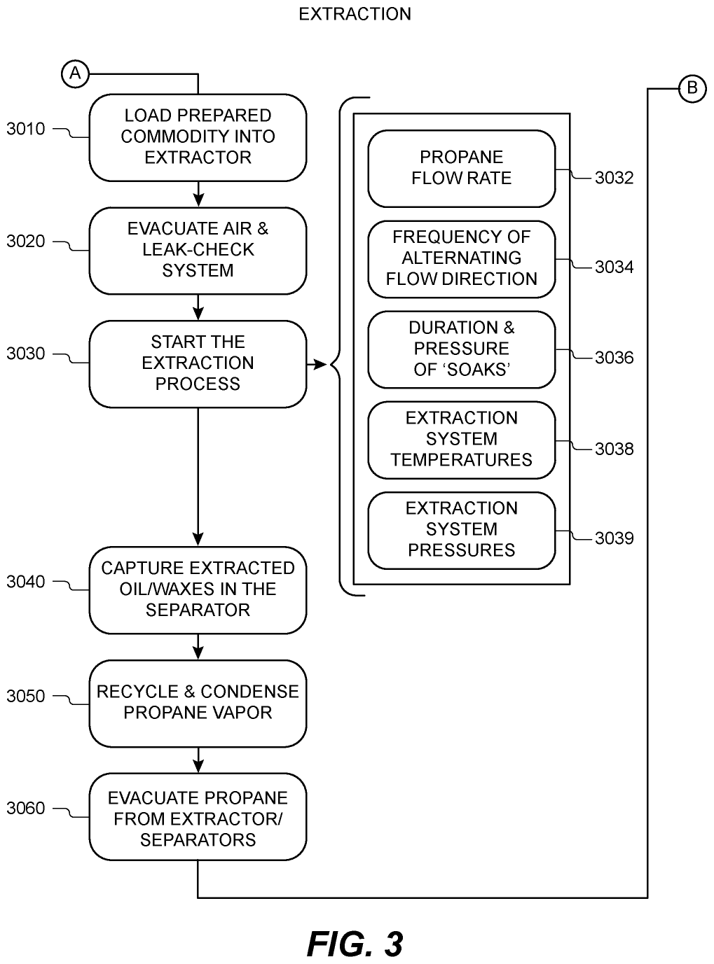

Now referring to FIG. 3, invention 10 contemplates the following steps of loading prepared commodity into extractor 3010, evacuating air and leak checking system 3020, starting the extraction process 3030, capturing extracted oil and or waxes in the separator 3040, recycling and or condensing propane vapor 3050, evacuating propane from extractor and separators 3060, and so forth.

Starting the extraction process 3030 may further include monitoring and or varying the propane flow rate 3032, monitoring and or varying the frequency of alternating the flow direction 3034, monitoring and or varying the duration and or pressure of soaks 3036, monitoring and or varying the extraction system temperatures 3038, monitoring and or varying the extraction system pressure 3039, and so forth.

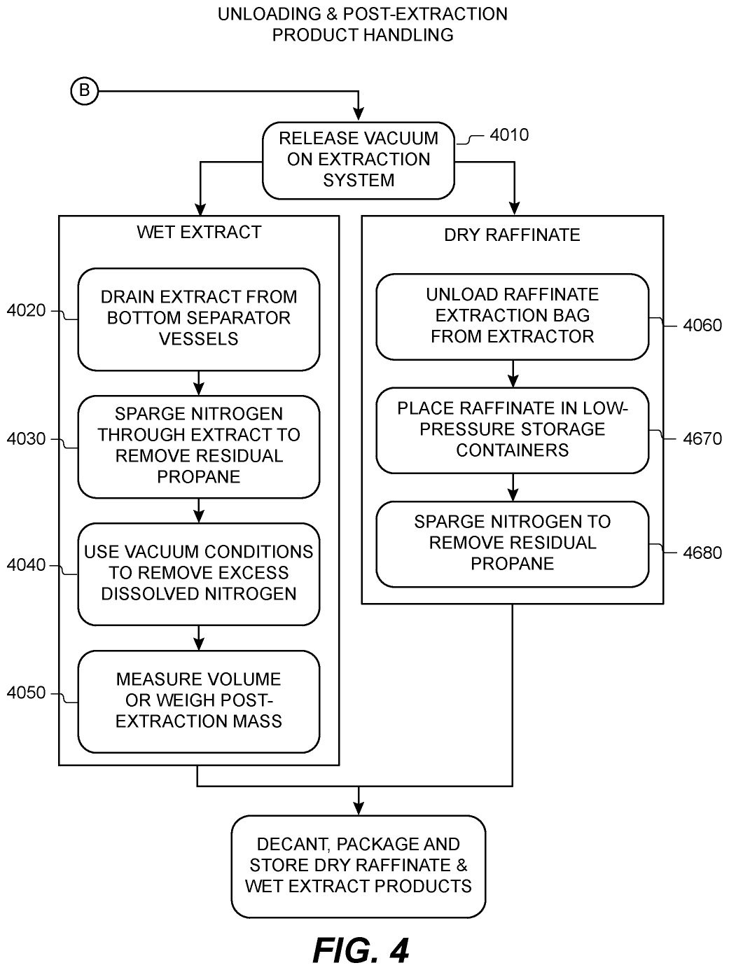

Now referring to FIG. 4, invention 10 contemplates the following steps releasing the vacuum on the extraction system 4010, and for a wet extract draining extract from bottom separator vessels 4020, sparging nitrogen through extract to remove residual propane 4030, using vacuum conditions to remove excess dissolved nitrogen 4040 and measuring volume and or weight post extraction mass 4050.

Now again referring to FIG. 4, invention 10 contemplates the following steps releasing the vacuum on the extraction system 4010, and for a dry raffinate, unloading raffinate extraction bag from extractor 4060, placing raffinate in low pressure storage containers 4670, and sparging nitrogen to remove residual propane 4680.

Changes may be made in the combinations, operations, and arrangements of the various parts and elements described herein without departing from the spirit and scope of the invention. Furthermore, names, titles, headings, and general division of the aforementioned are provided for convenience and should, therefore, not be considered limiting.

What is claimed:

1. A method to remove lipids from cellular matrices from a commodity comprising the steps:
sorting for debris in said commodity;
washing and drying said commodity;
milling and or slicing to reduce particle size of said commodity;
dehydrating to reduce moisture in said commodity;
transferring said commodity into extraction bags;
measuring volume and or weighing pre-extraction mass of said commodity;
loading prepared said commodity into extractor;
evacuating air and leak checking system;
starting the extraction process of said commodity;
capturing extracted oil and or waxes in the separator from said commodity;
recycling and or condensing propane vapor;
evacuating propane from extractor and separators;
starting the extraction process;
monitoring the propane flow rate;
monitoring and or varying the frequency of alternating the flow direction;
monitoring and or varying the duration and or pressure of soaks;
monitoring and or varying the extraction system temperatures;
monitoring and or varying the extraction system pressure;
releasing the vacuum on the extraction system;
draining extract from bottom separator vessels;
sparging nitrogen through extract to remove residual propane;
using vacuum conditions to remove excess dissolved nitrogen; and
measuring volume and or weight post extraction mass.
